(19) United States
(12) Patent Application Publication
(10) Pub. No.: US 2006/0020550 A1
(43) Pub. Date: Jan. 26, 2006

(54) System and method for secure data distribution and retrieval using encrypted media

(76) Inventors: Russel O. Fields, Manotick (CA); Mel C. Bond, Ottawa (CA); Stephen J. Davis, Nepean (CA)

Correspondence Address: Hoffman, Wasson & Gitler, P.C., Crystal Center 2 - Suite 522, 2461 South Clark Street, Arlington, VA, 22202, US

(21) Appl. No.: 11/186,940

(22) Filed: Jul. 22, 2005

Related U.S. Application Data
(60) Provisional application No. 60/589,814, filed on Jul. 22, 2004.

(51) Int. Cl. H04L 9/00

(52) U.S. Cl. 705/51

(57) ABSTRACT

A system and method for secure distribution and retrieval of valuable content on a standard-format, non-volatile digital storage media using encryption where authorization to access the content is managed through an enabling hardware device interacting with a centralized authentication and billing system linked by a secure communications path. The playing of the content in non-encrypted form requires the use of a device incorporating a standard media player and an interface to connect the enabling hardware device to the playing device.

### FIELD OF THE INVENTION

The present invention deals with a system and method for securely distributing data content using fixed media and, in particular, the secure distribution of data over encrypted media where the data can be retrieved using a commercial player connectable to a hardware device.

### BACKGROUND

Traditional methods for distributing content such as movies, games, pictures, data files, or other known content have been through the sale or rental of content in the form of, for example, digital video discs (DVDs) through conventional retail stores. The example of DVDs is used below to illustrate the background and invention, but is not meant to be limiting.

Conventional forms of DVD rentals are limited and inconvenient from a customer's perspective because the customer must make a trip to the store to rent a movie, the store may not have the movie the customer wants in stock, and the customer must make a return trip to the store within as little as 24 or 48 hours or face having to pay late-fee charges.

One solution to the above has been described in U.S. Pat. No. 6,584,450 to Hastings et al. Hastings teaches a computer-based approach to renting items to customers. Hastings describes a service where a limited number of items, such as DVDs, are shipped to a customer via mail for viewing at the customer's convenience. Customers must return the DVDs by mail in order to have new DVDs shipped to them for viewing. This “on-line rental” model fails to fully solve the problem of convenience as the customer must return the DVDs and fails to solve the problem of choice as the customer, at any point in time, may only choose from the few movies they have available at the time.

A further patent application of interest is U.S. patent application No. 202/0112235 to Ballou. Ballou teaches the encryption of a physical media, such as an optical disc, in a proprietary format that can be played back by a customer on a proprietary machine.

Ballou is premised on the use of non-standard multi-layered DVD formats to put multiple movies on a single disc. The reason for the proprietary set-top box in Ballou is the necessity of having a non-standard chip to read the non-standard DVD. The reason for the proprietary box in Ballou is, therefore, not a function of security of the content rather, it is a function of having to read non-standard discs.

Ballou uses a pay-per-use model which requires that each time a user wants to view a movie or obtain data from a disc, the user must pay.

The problem with Ballou is therefore that a proprietary player is required in order to view or use the data on the discs distributed by Ballou. These discs are encoded in a non-standard format. Further, it requires that each time a movie is to be viewed, the customer is required to phone to activate their service. In this respect, Ballou also requires that a solely pay-per-use model be used.

A further patent application of interest is U.S. Pat. No. 6,240,401 to Oren et al. Oren teaches a system and method for tracking and processing transactions for such purposes as creating billing records and detecting possible fraudulent activities. Content, such as DVDs, are only viewable in conjunction with the use of a specially-designed enabled player. The device itself requires a secure processor and requires memory on the DVD sub-system for storing transactions.

The problem with Oren is similar to the problem with Ballou in that a proprietary machine is required in order to view the contents of a DVD. This requires that the user invest in a proprietary player prior to being able to use the system of either Ballou or Oren.

### SUMMARY OF THE INVENTION

The present invention seeks to overcome the deficiencies in the prior art by providing a system and method where valuable content is encrypted on a standard-format, non-volatile digital storage media and where authorization to access the content is managed through an enabling hardware device interacting with a centralized authentication and billing system linked by a secure communications path. The playing of the content in non-encrypted form requires the use of a device incorporating a standard media player and an interface to connect the enabling hardware device to the playing device.

Preferably, enabling hardware devices and encrypted digital storage media may be obtained through an e-transaction, traditional retail store, or through a third-party. Other means of obtaining these hardware devices and encrypted digital storage media is contemplated to be within the scope of the present invention.

In one embodiment of the present system and method, a customer permanently retains the encrypted storage media for subsequent access. The encrypted storage media may be viewed based on a number of formulae, including, one-time payments, pay-per-use, subscription and third-party payment. Declining payments based on the number of times the particular encrypted storage media has been viewed could also be implemented. Other types of fee structures for viewing are also contemplated within the scope of the present invention.

A particular embodiment of this process could be for the rental of movies and games in a manner that builds a library of rental content in the home of the consumer with no requirement to return the physical media. Viewing of any of the movies in a user's library or playing of any games in a user's library can be done through the downloading of an appropriate decryption key to a customer's enabling hardware device.

The present system and method therefore provides an alternative method for the purchase or rental of valuable content whereby the customer will select and receive encrypted content in the standard format (for example, DVD) for playback on a suitably-equipped media player. The method allows for the permanent placement of encrypted content in the home of the customer allowing the customer to build a permanent library of rental content in the home. The customer then “rents” the content by requesting keys that will decrypt the content for viewing. This “one-way rental” model has the advantage over the incumbent models of allowing for a library of content to be created in the home or office from which to choose without the latency of leaving the home to acquire the physical media or waiting for mail delivery, without the inconvenience of returning the physical media and without the expense of late fees. By extension, the model can provide for a one-time fee for unlimited access that is the equivalent of the outright purchase of the content.

Further, the content can be viewed on any standard player that can be connected to an enabling hardware device. In one embodiment, the enabling hardware device could be a Universal Serial Bus (USB) connectable device such as a dongle. In the case of movies or games, the playback device could be a gaming console, such as the X-Box™, or PlayStation2™, a personal computer, a mobile device such as a cellular telephone or a personal digital assistant, a portable gaming system such as a PSP™. Other playback devices that are commercially available would be known to those skilled in the art.

The present application therefore provides a system for secure distribution and retrieval of data comprising: non-volatile, standard format digital storage medium for securely storing encrypted data; a media player adapted to play said standard format digital storage medium; a centralized authentication system capable of distributing a key to decrypt said encrypted data; and an enabling hardware device capable of storing the key received from said centralized authentication system, said enabling hardware adapted to interact with said media player for decryption of said data.

The present application further provides a method for secure distribution and retrieval of data comprising the steps of: obtaining a non-volatile, standard format digital storage medium for securely storing encrypted data; acquiring an enabling hardware device; loading a key for decrypting said encrypted data onto said enabling hardware device; interfacing said enabling hardware device with a media player capable of reading said standard format digital storage medium, whereby said combination of media player and enabling hardware device with said key is capable of decrypting said encrypted data; and retrieving said data in an unencrypted format.

### BRIEF DESCRIPTION OF THE DRAWINGS

The present invention will be better understood with reference to the drawings in which:

FIG. 1 is a process diagram of the various steps and elements of the present system and method;

FIG. 2 is a flow-chart of an example ordering system according to the method of the present invention;

FIG. 3 is a process diagram showing the interaction between a media player and a television including the hardware device for decryption;

FIG. 4 is a process diagram showing communications between the media player, billing server and television according to a method of the present invention; and

FIG. 5 is a block diagram of an alternative exemplary system in which the media player is a mobile device.

### DETAILED DESCRIPTION OF THE DRAWINGS

The present method and system provide a means for secure data distribution using an encrypted media. In the present method and system, the user receives encrypted medium and can access the data on this medium using a commercial player and a key that the user may obtain from the service provider. The user is able to keep the medium and thereby build a library for future use.

In the description below, the example of the distribution of movies in DVD format is presented. This is, however, not meant to be limiting, and the present invention contemplates the distribution of any type of data on a physical medium. This can be, but is not limited to, games, music, software or any other type of data. The physical medium can be a DVD, CD, flash memory, hard drive, other non-volatile memory, or any other physical media known to those skilled in the art.

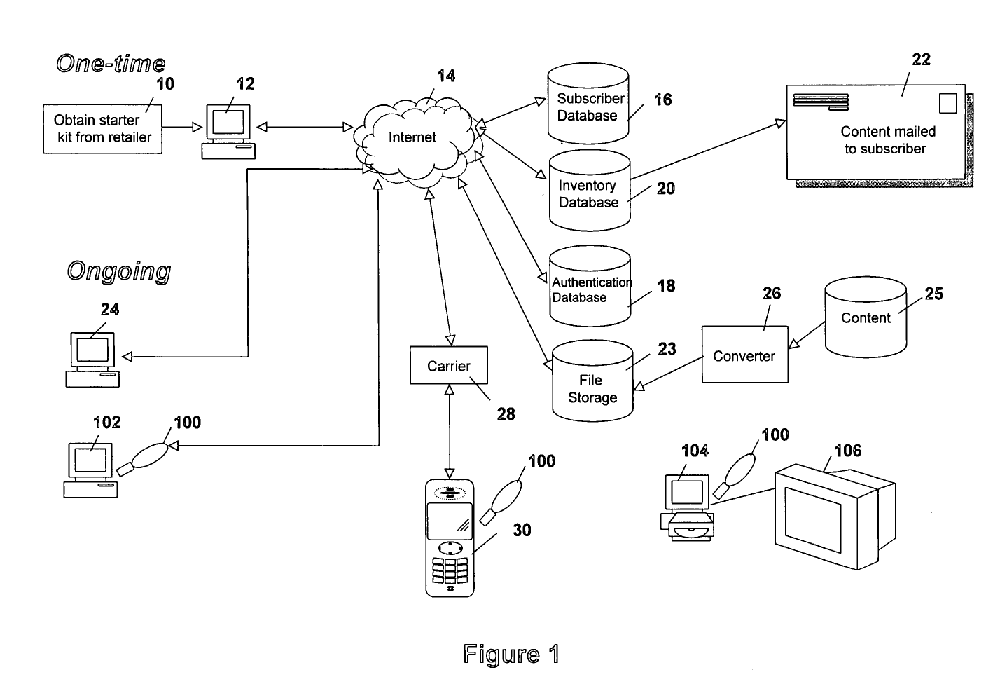

Reference is now made to FIG. 1. FIG. 1 shows a method and system for obtaining and viewing a DVD according to the system and method of the present invention. Specifically, a user in Step 10 obtains a starter kit from a retailer. A starter kit can include a hardware component needed for decrypting the data stored on the DVD and, potentially, could also include a number of DVDs. It is contemplated that the starter kit could be obtained from either a retailer or by ordering a kit from a service provider.

A user then, in Step 12, can activate the starter kit over a computer network, such as the internet or on any other type of network as known to those skilled in the art. If a starter kit was not obtained in Step 10, then in Step 12, it can be ordered on-line.

An order from Step 12 proceeds through a network 14, such as the internet, and a user can log in to various databases in order to complete subscription details and, in subsequent transactions, to be authorized and to order DVDs. These databases include a subscriber database 16 for storing information about a user, an authentication database 18 for password control and to ensure that a user is authenticated, and an inventory database 20 to store an inventory of current movies available. Once logged in to these databases, the user can order DVDs as will be described in more detail below.

At the completion of a DVD-ordering session, DVDs are mailed in Step 22 to the user. In the present invention it is contemplated that current industry-standard media formats such as digital video discs (DVDs), compact discs (CDs), or other standard formats will be used to store the data. The content of the discs will, however, be encrypted using private-key encryption and, in order to read the content of the disc, a key is required.

The present invention further contemplates future media formats once they are standardized by the industry through either formal industry standard bodies or on a defacto basis. For example, high-definition video media formats, such as High Definition-Digital Video Discs (HD-DVDs), Blu-Ray Discs, or other future formats are contemplated. The use of standard media formats allows the playback on standard media players available to customers as long as these media players have a means to connect a hardware device.

It is further contemplated that the present invention could be used on permanent storage devices such as hard drives.

In an alternative embodiment, it is contemplated that a user with a mobile device 30 can obtain content through a carrier 28 and over the air. In this embodiment, the user accesses a file storage database 23, which has files formatted for mobile device 30. The content within file storage 23 is obtained from a content database 25 and passed through a converter 26 to convert the file to the proper format. The content could also be obtained by the user through a physical medium such as a flash card that could be inserted into the mobile device 30. Other alternatives include the use of a hard drive on the mobile device 30 as the physical medium and the provisioning of the data by the carrier at, for example, a store or service center.

A user who is already registered within the system can log in through network 14 to an authentication database 18 and thereby access inventory database 20. A customer can then order DVDs or other content pursuant to any type of subscription model. Such subscription models include a flat monthly fee for a certain number of DVDs ordered with a surcharge for extra DVDs above the minimum number, a service in which DVDs are ordered individually and at any time, or other subscription type services known to those skilled in the art.

A web-site will preferably permit the customer to select the content they wish to receive in the format they wish to receive it in. A customer may be assisted in this selection through software programs designed to assist customers in finding the content they want based on selected criteria and/or past selections. For example, if a customer is selecting movies, the customer may be able to request lists of available titles by genre, favourite actor, favourite director, country of origin, language, or other type of sortable method known to those skilled in the art. The presence of software systems for enabling and processing e-commerce transactions, while part of the present system, is a commercially-available aspect and, as such, the present system and method is independent of any specific implementation of e-commerce and selection software.

Once the order is complete, DVDs or other physical media are again mailed to the subscriber in Step 22. As will be appreciated by those skilled in the art, the physical media containing the encrypted content may be sent to the customer by mail, special delivery or by any other means at the disposal of the content distributor. The media could also be provided through a physical store or be picked up at a physical location.

Once a user receives the physical media in Step 22, this physical media is owned by the customer. The customer retains ownership of the physical media, but has no rights to access or use the encrypted content contained on the physical media until such time, and under such conditions as the customer is authorized to do so.

In an alternative embodiment to the above, a customer may be able to purchase or otherwise receive encrypted media through a retail store offering the encrypted media. In this case, the customer may go to the retail outlet to pick up their encrypted media or it may be delivered by the retail outlet using any existing delivery mechanism.

In a further alternative embodiment, encrypted content may be delivered electronically over a secure communication link to a permanent storage device.

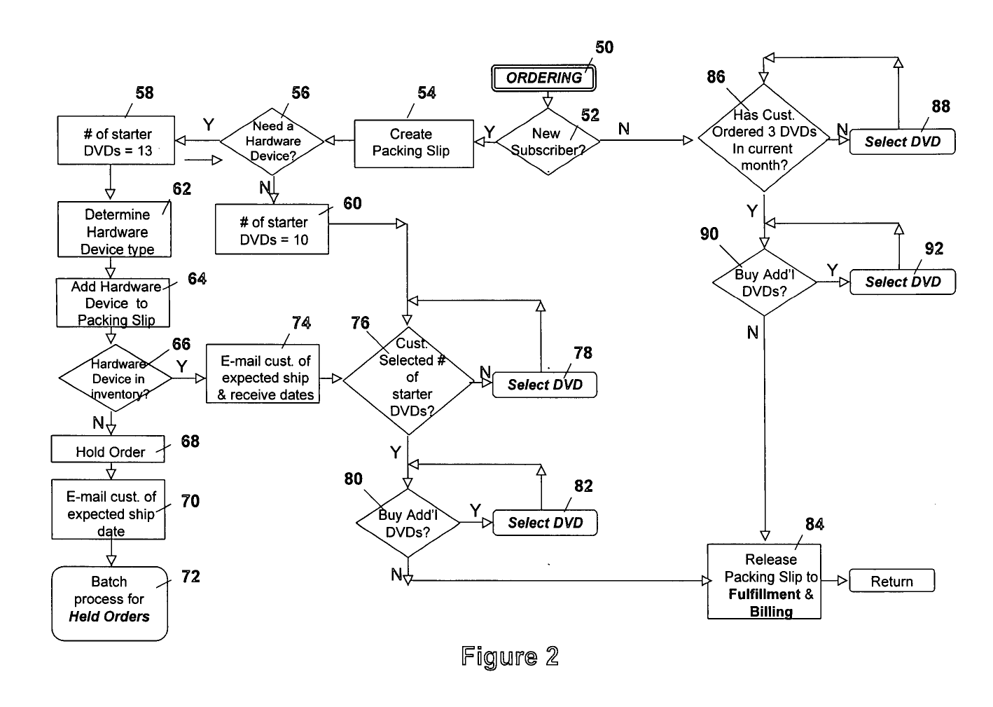

One example of the above on-line ordering process is illustrated in FIG. 2. FIG. 2 shows a method for ordering a DVD within the method of the present invention. A potential customer begins ordering at Step 50 and proceeds to Step 52 in which the system determines whether the customer is a new subscriber. If the customer is a new subscriber, the system proceeds to Step 54 in which a packing slip is created and the system proceeds to Step 56. In Step 56, the system determines whether the customer needs a hardware device in order to decrypt the encrypted media. If yes, the system moves to Step 58 in which the number of starter DVDs is set. In the example of FIG. 2, the number of DVDs is set to 13 if the customer requires the hardware device. Conversely, if the customer does not require a media key, then the number of starter DVDs can also be set to a number that is independent from the number set in Step 58. In Step 60, in the example of FIG. 2, the number of DVDs is set to 10 for a customer that does not need a hardware device.

From Step 58, the system proceeds to Step 62. In Step 62 the type of hardware device is determined. This will depend on the media player the user intends to use.

The system next moves to Step 64 in which the hardware device is added to the packing slip and in Step 66 the system checks whether the hardware device is in inventory.

If the hardware device is not in inventory, the system proceeds to Step 68 in which the order is held and an e-mail is generated in Step 72 informing the customer of the expected shipment date. The order is then placed in a batch process to be processed at a future date in Step 72.

If, in Step 66, it is found that the hardware device is in inventory, the system proceeds to Step 74 in which the customer is e-mailed the expected date s/he will receive their order and the system proceeds to Step 76. The system also proceeds to Step 76 from Step 60 in which the customer did not require a hardware device. In Step 76, the system determines whether the customer has selected the number of starter DVDs according to the number determined either in Step 58 or in Step 60. If not, the system proceeds to Step 78 in which a DVD is selected and loops between Steps 76 and 78 until the number of starter DVDs has been selected.

Once of the number of starter DVDs has been selected, the system proceeds to Step 80 in which it determines whether the customer wishes to buy additional DVDs. If yes, the system proceeds to Step 82 in which a DVD is selected and the system loops between Steps 80 and 82 until the customer decides they do not wish to buy any further DVDs. At this point, the system proceeds to Step 84 in which the DVDs and, possibly, the hardware device, found on the packing slip are released to the fulfilment and billing department, at which point, the order is filled and sent to the customer.

If, in Step 52, it is determined that the customer is not a new subscriber, the system proceeds to Step 86. In Step 86 the system determines whether the customer has ordered the pre-determined number of DVDs for that month. This assumes that the customer is on a monthly subscription in which they are to receive a certain number of DVDs each month and, in the example of FIG. 2, this number has been set to 3. However, as will be appreciated by those skilled in the art, other types of subscription formats are also possible.

From Step 86, if the customer has not ordered the pre-determined number of DVDs for that month, the system proceeds to Step 88 in which a user selects a DVD and the system loops between Steps 86 and 88 until the number of DVDs for the month have been selected, at which point, the system proceeds to Step 90. In Step 90, the system determines whether the user wishes to buy additional DVDs and, if the user does, the system loops between Steps 90 and 92 until the user does not wish to purchase any more DVDs. Step 92 is the selection of a DVD. From Step 90, the system proceeds to Step 84 in which the packing slip is released and the order is fulfilled and billed to the customer.

Referring again to FIG. 1, once a user receives the physical media that s/he has ordered, and which were mailed in Step 22, the user then owns these physical media and may periodically wish to view them. In order to view the encrypted content, a hardware device 100 is required. The hardware device 100 may be an external dongle that attaches to a computing device or media player by means of a standard connection interface, for example, a Universal Serial Bus (USB) connection. It may also be a hardware component housed internally within the media player, preferably on a non-integrated basis with respect to the rest of the media player hardware. Other examples of device 100 could include a short range wireless device such as a Bluetooth™ device for communicating with the media player, or could include a portion of the physical medium itself, such as, for example, a portion of a flash card that also stores the content. In one embodiment, the overall system itself could also be the hardware key.

The hardware device 100 can be programmed to be connected to the media player either by allowing enabling software to be loaded onto the media player once, prior to reading any encrypted media or, alternatively, enabling software may be provided on the individual physical media also containing the encrypted content.

As described above, the customer may purchase the hardware device 100 either through an authorized web-site or through an authorized conventional retail store. The customer may also receive the requisite hardware from a third-party, including, for example, content distributors whereby ownership of the requisite hardware will be determined between the customer and the third-party.

As illustrated in FIG. 1, once the user has a hardware device 100, it can be attached to or interact with any device 102 that can be connected over a network 14 to subscriber database 16 and an authentication database 18. Authentication database 18 includes software to determine the rights of the owner of the enabling hardware to access specified encrypted content. It further includes software pertaining to the permissions and restrictions on access to specified content as provided by the content owner and/or content distributor. It also provides information pertaining to encryption keys required to decrypt encrypted content. The above information is used to ensure that keys are only distributed to owners with the rights to get the keys and only those owners with permissions or that do not fall within restrictions can get those keys. For example, encrypted media can distributed prior to a release date. A customer will not be able to obtain the key for decrypting the encrypted content until the release date and, thus, will not be able to view the movie ahead of time.

The authentication system further includes software that enables communication to be established with device 102 over a secure communication path. Communications over secure communication paths are known to those skilled in the art, and can include password authentication as well as a Secure Socket Layer (SSL) communications path over the internet. Other means of secure communications are also known to those skilled in the art.

The authentication system further includes software systems that enable the customer to request decryption keys for content they specify. Identification of the content may be provided directly by the customer or may be selected by the customer from a menu of content provided by the software system, which may be either a general list of content available or a customized list of the encrypted content known to be in the user's personal library.

The authentication system further includes software systems that transmit decryption keys and authorization parameters which can include the authorization date, termination date, number of uses, etc., over the secure communication path to device 102 for enabling hardware device 100.

The authentication system further can include software systems that collect usage data from the enabling hardware device 100 for billing and customer management purposes.

As will be appreciated by those skilled in the art, the operator of the authentication system may or may not be the content owner or content distributor and may be a third-party contracted to provide the authentication.

As will be appreciated, device 102 can be any device capable of communicating over a network, and can include a personal computer, a game console with a modem, a mobile device with wireless communication means, or other devices known to those skilled in the art.

Referring again to FIG. 1, once hardware device 100 has obtained the key for the encrypted content, hardware device 100 can be attached to the media player. The media player may or may not be the original device on which the key was downloaded and is referred to herein as media player 104.

Examples of media player 104 that meet the criteria of having a USB or similar connection interface and sufficient memory and processing power, in combination with the enabling hardware device 100, are media-capable personal computers and certain game consoles, for example, Sony PlayStation2™ and PSX™ and Microsoft X-Box™. Other examples include mobile devices such as cellular telephones, PDAs, wireless data devices, or mobile game consoles. Other media players 104 will be known to those skilled in the art.

Alternatively, the media player 104 does not need to have an external USB or other interface (such as Bluetooth™) if it has the enabling hardware device 100 internally.

As will be appreciated by those skilled in the art, media player 104 does not need to be connected to the internet since hardware device 100 can be transported between an internet-connected device 102 and media player 104. However, in some embodiments, device 102 and media player 104 will be the same.

The hardware device 100 needs to be connected to the media player 104 at the time of reading the encrypted media in order for the encrypted content to be decrypted. All decryption codes and authorization parameters are preferably retained in the enabling hardware device 100. This information may be downloaded onto the enabling hardware device 100 from a separate network-connected user device 102 such as a personal computer. Enabling hardware device 100 may then be disconnected from the network-connected device 102 and re-connected to the media player 104. By not requiring the connection to a communication path at the time of reading the encrypted content, this allows for portability of the media player 104, for example, taking an enabled lap-top computer on a plane, or taking an enabled game console to the cottage.

Media device 104 does not need to have communication abilities. For example, in the case of encrypted movies or games, these could be played on a game console not having any communications capabilities. Once hardware device 100 has been attached to media device 104 and the proper encrypted media is placed within the media player 104, media player 104 can play like any other DVD, and be, for example, viewed on a television set 106.

Encrypted media mailed in Step 22 of FIG. 1 and being read by media player 104 needs encryption in order to prevent unauthorized viewing. Various encryption techniques are known to those skilled in the art. The level of encryption needs to be sufficient in order to minimize “free” viewing of content. In one embodiment, it is envisioned that 256 bit AES-CTR encryption is used. Decryption must also be sufficiently fast in order to minimize delays imposed by the decryption mechanism. Also, the existing DVD Content Scrambling System (CSS) will remain on the DVD discs that are shipped by a supplier.

The protection, in this case, is a closed system. Records will exist of all customers that are viewing encrypted media and the hardware device 100 needs to connect at some point to the authorization server in order to download keys and allow the customer account to be updated with new system charges.

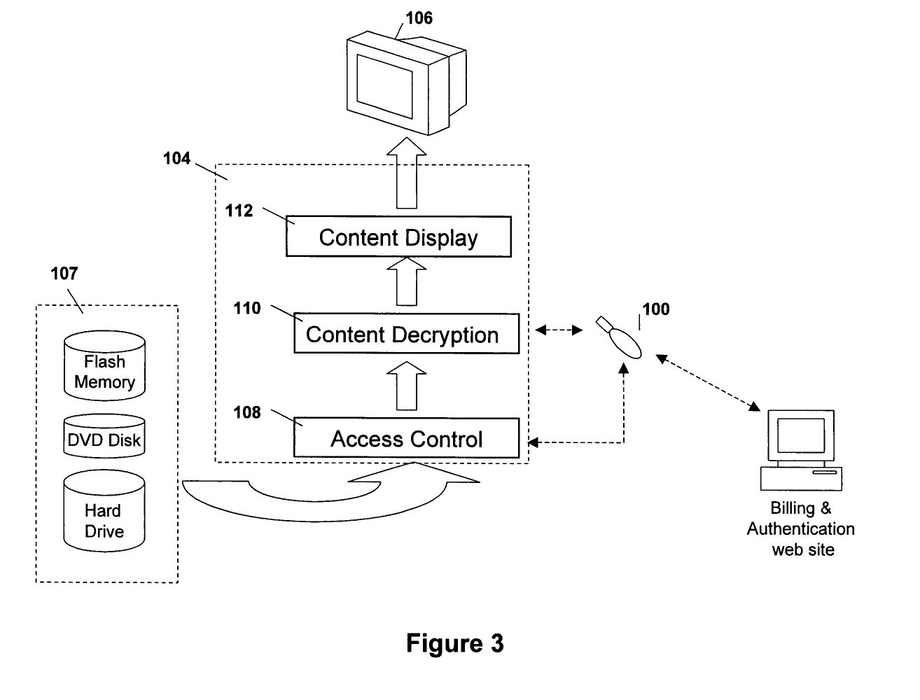

Reference is now made to FIG. 3. FIG. 3 shows the intermediary steps between the content on an encrypted medium 107 and viewing on a display 106. In this case, media player 104 will include access control 108, content decryption 110, and content display 112. Access control 108 and content decryption 110 interact with hardware device 100 in order to decrypt and access content on the encrypted medium 107. Keys are stored on hardware device 100. In one embodiment, hardware device 100 may be used for both authentication and decryption. Alternatively, hardware device 100 may be used for authentication but actual decryption occurs on the host processor.

As will be appreciated, encrypted medium 107 can include various media, including CDs, DVDs, hard drives, or flash memory cards, among others. The encrypted medium could be external to media player 104, or could be internal to it.

Display 106 could include any display capable of showing the content. This could include a television set for showing DVDs, a computer screen for showing files, movies, pictures or other content, or could include a display such as those built into mobile devices or portable video game consoles. The above is not meant to limit the type of display. Further, display 106 could be internal or external to media player 104.

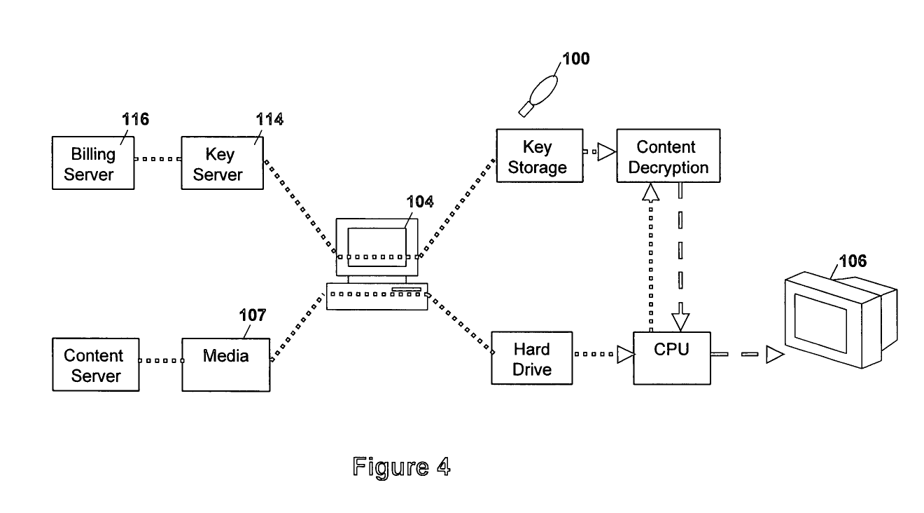

Reference is now made to FIG. 4. FIG. 4 shows the interaction between media player 104 and display 106 and the way the content is provided in a decrypted format to display 106. Specifically, media player 104 interacts with the key server 114 in order to obtain a key which is stored in hardware device 100. Preferably, communications between the key server 114 and hardware device 100 is performed over a separate SSL connection. Hardware device 100 is authenticated using an embedded private key and a customer or public key that is stored on billing server 116.

In a preferred embodiment, the key obtained from billing server 116 is preferably deleted from hardware device 100 once a time limit for the key expires. This prevents the customer from a setting a system clock back to preserve view time on the content.

The above provides for controlled access to encrypted content. Content owners and distributors can control a customer's access to the encrypted content on an individual, group or collective basis through specification of authorization parameters. Individual authorization parameters can apply to a specifically-identified enabling hardware device 100. For example, customer ‘X’, and only customer ‘X’, may be allowed to view the content for a specified period beginning at a specified date and time.

Group authorization applies to a defined group of enabling hardware devices where the definition of the group is provided by the content owner or distributor. For example, all devices belonging to a group of movie critics could be given one set of authorization parameters and all other devices given a separate set of authorization parameters.

Collective authorization applies the same authorization parameters to all enabling hardware devices requesting access to the specified encrypted media.

Fees for the right to view or otherwise use the content contained on encrypted media are charged by the content owners and/or content distributors. As one skilled in the art will appreciate, various methods for charging for content can be used. Examples of billing methods can include:

One-Time Fee—a single fee is applied giving user rights as specified by the content owner/content distributor on a one-time basis. One embodiment of this is to provide unlimited access to the content for a single, one-time fee.

Pay-per-Use—an individual fee is charged for each use of the specified content. The definition of a “single” use may be specified by the content owner/content distributor. For example, a “single” use could be single viewing of a movie or it could be unlimited viewing of a specified movie over a specified time period, for example, 48 hours. The price may differ by the type of content. For example, a distributor of encrypted movie content may charge one price for new releases, a different price for movies older than a certain number of months, and a different price for children's movies. Similarly, a distributor of encrypted media content may charge one price for movies, a different price for TV shows, and a different price for games.

Pre-payment—a user may be asked to pre-pay for their access to content. The user's pre-paid account may then be reduced by the price of each authorization at the time the content is requested. The pre-payment account may be replenished on-demand by the user using a credit card-verifiable method of payment, either electronically through an e-commerce connection or manually by telephone. The pre-payment may be replenished automatically by pre-authorizing charge to the user's credit or verifiable method of payment either when the account gets below a specified threshold or at a specified time interval.

Subscription—a user may subscribe to a service whereby the user pays a recurring fee at a specified time interval for access to a pre-defined quantity of encrypted content. For example, in the case of movie content, access to a pre-defined number of movies over the subscription interval, with unlimited access to the specified movies during the subscription interval or access to a pre-defined maximum number of movies that may be authorized for viewing over the period of time that is less than the subscription interval. For example, at most, X movies can be authorized for viewing during any Y hour period in the month, allowing for X different movies to be viewed (but no more than X) in each Y hour period in this subscription interval.

Third-Party Payment—a third-party may choose to pay the content owner/content distributor some, or all, of the price of a user's right to access encrypted media content. For example, a sponsor may, as part of a promotion, subsidize access to content to which it is related by virtue of a sponsorship agreement.

In one embodiment contemplated by the inventor, a distributor of encrypted media may not be the same party that operates the authentication system required to authorize and track usage of encrypted media. In this case, the operator of the authentication system may charge the distributor of the encrypted media for the use of the authentication system.

The above, therefore, describes a system in which valuable content is encrypted in digital form on a standard, non-volatile digital storage media; the encrypted content is distributed to user locations by various means where it is permanently retained, by the user, for subsequent access; the user requires an enabling hardware device into which decryption keys are downloaded from an authentication server; the user can access a centralized authentication server containing the decryption keys by means of a secure communications path connected to a user-controlled device having the capability to enable the downloading of data from the authentication server to the enabling hardware device, where the enabling hardware device is connected to the customer-controlled device by means of a Universal Serial Bus (USB) port or similar device for connecting the enabling hardware device to the media player; the centralized authentication server verifies the enabling hardware device is authorized to receive the decryption keys for the specified content; the content is accessed using a media player device that contains, at minimum, a standard player for reading the standard digital storage media containing the encrypted content, a means for connecting the enabling hardware device 100 to the media player 104, and sufficient memory and processing capability, in combination with the memory and processing capability of the enabling hardware device 100, to execute instructions to be carried out in hardware or software that will decrypt the content into its non-encrypted form for access by the authorized user; the customer-controlled device used to download decryption keys into the enabling hardware device need not be the same device that the encrypted digital storage media is played on; access to the content in un-encrypted form is controlled by the owner and/or distributor of the content with respect to the time period within which and with respect to the frequency with which it may be accessed; the user and/or a third-party may be charged a fee for obtaining the encrypted content; the user and/or a third-party may be charged a fee for user authentication and for the downloading of decryption keys; and the user and/or a third-party may be charged a fee representing the value of the content to be accessed and this fee may be applied in various ways including a one-time fee, a pay-per-use, a subscription, or a pre-payment, as described above.

The present system differentiates itself from the prior art by providing content in a standard format that can ultimately be viewed by a commercially-available media player, having several different payment models, allowing the charging of the hardware device to be done on any network-connected device independent of the device that will play the media and by providing ownership of the physical media to the customer. The media is further pressed, burned or encoded using standard format.

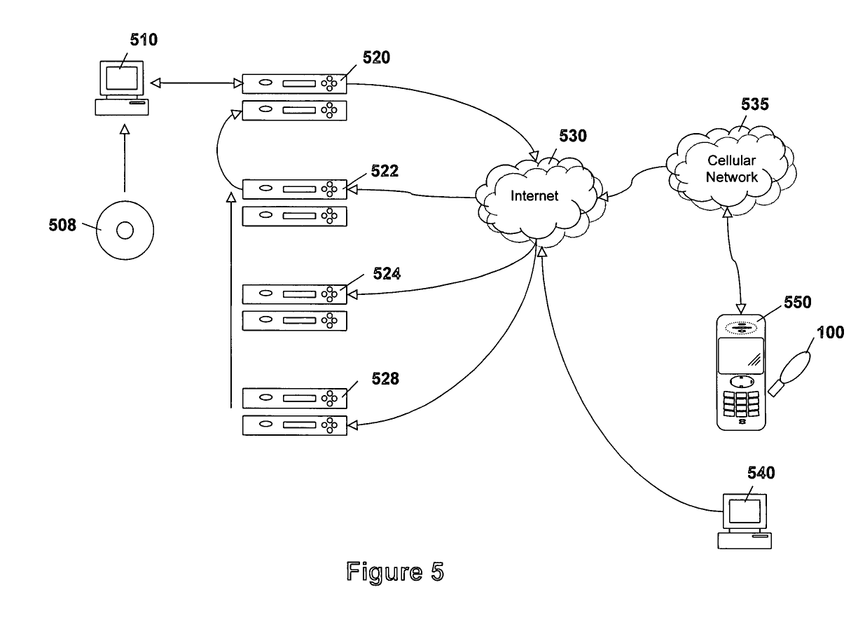

Reference is now made to FIG. 5. FIG. 5 is an exemplary block diagram of the present system and method for use with content on a mobile device 550. The system of FIG. 5 is meant to be illustrative, and other embodiments of the system would be known to those skilled in the art.

Original content 508 can be acquired in one of two ways. The first is through a mobile carrier over cellular network 535 from mobile device 550. The second is from a content provider using a PC or a mobile device over the Internet or other network 530. As will be appreciated, if a mobile device is used, the cellular network 535 is also used to obtain access to the Internet or network 530. Content can thus be sourced over the cellular network.

A user, in an exemplary system, accesses the content provider through e-commerce servers 528, which in turn access web servers 524 and a transaction server 522. Further, in one model, content owners and creators might port content to a provider using various means, including via physical media or over the internet.

An account for the user is created through the e-commerce server 528, which prompts the user for information. This information might include user identifiers, passwords, profile information, or identification of the cellular telephone. This list is not exhaustive, nor do all the items on this list need to be used to create an account. If age verification is required this information might further include credit card information. This account may also be set up via the mobile device.

Once the e-commerce server 528 receives all of the information, it passes it to transaction server 522, which creates the account. In the preferred embodiment, the account is tied to a particular mobile device number. Further, billing in the preferred embodiment is done through the carrier servicing the mobile device rather than by the content provider.

Transaction server 522 personalizes a Java application that is used to unlock downloaded clips on the mobile device 550. This java application is passed to download servers 520.

The transaction server is further used to inform the mobile device 550 that a download is waiting. This could, for example, be done through a short message service (SMS) message to the mobile device 550. The mobile device then initiates a transaction with download servers 520 to download the personalized Java application into the mobile device.

Java applications in the above are merely exemplary, and other applications or languages could be used.

Once the mobile device 550 is registered with an account, it can be used to obtain and view content from the content provider. This can for example be done through a web server 524. If a user selects content to download, transaction server 522 is used to verify that the mobile number matches an active account. Transaction server 522 may further optionally request that a user name or personal identification number (PIN) be entered prior to the transaction being verified.

The transaction server 522 may further request a personalized clip for the specific mobile device type of mobile device 550 from download server 520. This information is received from the original content 508 and is translated by authoring tools 510.

The mobile device is then informed that content is waiting on download server 520 and the personalized Java application on mobile device 550 starts the download from download server 520. Once the download is complete, download server 520 may remove the content from itself.

Once the content is downloaded onto mobile device 550, it can be viewed through the use of a key. The key may be a hardware key 100 as described above, or may be a key that resides within mobile device 550, either as separate hardware or part of existing hardware on mobile device 550.

As will be appreciated by those skilled in the art, the media player in this case is within mobile device 550 itself. Further, a display in this case is the display for mobile device 550. When the content is translated, this could be for the mobile device itself, for example to optimize the content for the screen size and resolution on the mobile device.

The key in this case is downloaded in the same manner as with the example of FIG. 1 above. It is stored in a hardware module, either external or internal to the mobile device 550 and personalized Java application uses the key to unlock the content and allow the user to see the content. It is further contemplated that a user need to enter a PIN prior to the content being displayed in order to safeguard the content in case the mobile device is picked up by a third party. For example, if age restrictions allowed only certain users to view content, then a younger third party who finds the mobile device will not be able to view this content.

As will be appreciated, the above provides security for the content. The personalized Java application is tied to the mobile device, as is the content that is downloaded from download server 520. While the content can be transferred to another device, the key will not unlock the content since the personalized Java application is no longer tied to the new device.

The embodiments described herein are examples of structures, systems, or methods having elements corresponding to the elements of the application. This written description may enable those skilled in the art to make and use embodiments having alternative elements that likewise correspond to the elements of the application. The intended scope of the application thus includes other structures, systems, or methods that do not differ from the application as described herein, and further includes other structures, systems, or methods with insubstantial differences from the application as described herein.

What is claimed is:

1. A system for secure distribution and retrieval of data comprising:
non-volatile, standard format digital storage medium for securely storing encrypted data;
a media player adapted to play said standard format digital storage medium;
a centralized authentication system capable of distributing a key to decrypt said encrypted data; and
an enabling hardware device capable of storing the key received from said centralized authentication system, said enabling hardware adapted to interact with said media player for decryption of said data.2. The system of claim 1, wherein said enabling hardware device is adapted to perform the decryption of said data.

2. The system of claim 1, wherein said enabling hardware is adapted to perform the decryption of said data.

3. The system of claim 1, wherein said media player is adapted to perform the decryption of said data.

4. The system of claim 1, wherein said key is tied to a particular non-volatile, standard format digital storage medium.

5. The system of claim 1, wherein said key is tied to the media player.

6. The system of claim 1, wherein said media player is a commercially available media player.

7. The system of claim 1, wherein said non-volatile, standard format digital storage medium is selected from the group consisting of: a digital video disc; a compact disc; a hard drive; a flash memory card; and a digital storage memory card.

8. The system of claim 7, wherein said media player is a device selected from the group consisting of: a game console; a personal computer; and a laptop computer.

9. The system of claim 1, wherein the media player is a mobile device.

10. The system of claim 1, wherein the enabling hardware device is an external device to the media player and is connectable to the media player through an interface on the media player.

11. The system of claim 10, wherein the interface is selected from the group consisting of a Universal Serial Bus interface and a Bluetooth™ interface.

12. The system of claim 1, wherein the enabling hardware device is an internal device within the media player or within the non-volatile standard format digital storage medium.

13. A method for secure distribution and retrieval of data comprising the steps of:
obtaining a non-volatile, standard format digital storage medium for securely storing encrypted data;
acquiring an enabling hardware device;
loading a key for decrypting said encrypted data onto said enabling hardware device;
interfacing said enabling hardware device with a media player capable of reading said standard format digital storage medium, whereby said combination of media player and enabling hardware device with said key is capable of decrypting said encrypted data; and
retrieving said data in an unencrypted format.

14. The method of claim 13, wherein said interfacing step enables decryption of said encrypted data in said enabling hardware device.

15. The method of claim 13, wherein said interfacing step enables decryption of said encrypted data in said media player.

16. The method of claim 13, wherein said media player is embodied in a device selected from the group consisting of: a game console; a personal computer; a laptop computer and a mobile device.

17. The method of claim 16, wherein said media player is a commercially available media player.

18. The method of claim 13, wherein said non-volatile, standard format digital storage medium is selected from the group consisting of: a digital video disc; a compact disc; a hard drive; a digital storage memory card and a flash memory card.

19. The method of claim 13, wherein said key is tied to a particular non-volatile, standard format digital storage medium or a particular media player.

20. The method of claim 13, wherein said interfacing step is performed through an interface selected from the group consisting of a Universal Serial Bus interface and a Bluetooth™ interface.
